(19) United States
(12) Patent Application Publication
(10) Pub. No.: US 2023/0131756 A1
(43) Pub. Date: Apr. 27, 2023

(54) COLD INSULATOR, INFORMATION MANAGEMENT DEVICE, COLD INSULATOR MANAGEMENT SYSTEM, AND FREEZER STORAGE CONTROL SYSTEM

(71) Applicant: SHARP KABUSHIKI KAISHA, Sakai City, Osaka (JP)

(72) Inventors: KEI KASAHARA, Sakai City, Osaka (JP); SATOSHI SHIMIZU, Sakai City, Osaka (JP); MASATO SASAKI, Sakai City, Osaka (JP); MASAYUKI NAKANO, Sakai City, Osaka (JP); TOMOHISA YOSHIE, Sakai City, Osaka (JP); HWISIM HWANG, Sakai City, Osaka (JP); MASAKAZU KAMURA, Sakai City, Osaka (JP); YUKA UTSUMI, Sakai City, Osaka (JP)

(21) Appl. No.: 17/790,932

(22) PCT Filed: Dec. 14, 2020
(86) PCT No.: PCT/JP2020/046444

§ 371 Date: Dec. 23, 2022

(30) Foreign Application Priority Data
Jan. 10, 2020 (JP) 2020-002821

(51) Int. Cl. F25D 16/00; G01K 1/024; G01K 1/143; B65D 81/38

(52) U.S. Cl. CPC F25D 16/00; G01K 1/024; G01K 1/143; B65D 81/38

(57) ABSTRACT

The present disclosure acquires information on a cold insulator. The cold insulator includes: at least one cold storage material; a packaging unit configured to package the at least one cold storage material; one or more first temperature sensors disposed on the packaging unit; and a transmission unit disposed on the packaging unit to transmit a result of measurement performed by the one or more first temperature sensors to an external device.

### TECHNICAL FIELD

The following disclosure relates to cold insulators, information management devices, cold insulator management systems, and freezer storage control systems.

The present application claims the benefit of priority to Japanese Patent Application, Tokugan, No. 2020-002821 filed on Jan. 10, 2020, the entire contents of which are incorporated herein by reference.

### BACKGROUND ART

Heat insulation chambers are conventionally known for transporting an article in a low temperature environment by using a cold insulator. As an example, Patent Literature 1 discloses a heat insulation chamber, containing therein a cold insulator, that is capable of recognizing changes in the temperature of the article during transport by being equipped with a temperature probe and a temperature recorder.

### CITATION LIST

### Patent Literature

Patent Literature 1: Specification of Chinese Utility Model No. 206798212

### SUMMARY OF INVENTION

### Technical Problem

However, in the heat insulation chamber such as that described above, the temperature sensor is disposed close to the article to measure the temperature of the article stored in the heat insulation chamber for cold storage. Therefore, in the heat insulation chamber such as that described above, no consideration is given to the acquisition of the condition of the cold insulator itself that is placed in the heat insulation chamber.

The present disclosure, in an aspect thereof, has an object to acquire information on the cold insulator.

### Solution to Problem

To solve this issue, the present disclosure, in one aspect thereof, is directed to a cold insulator including: at least one cold storage material; a packaging unit configured to package the at least one cold storage material; one or more temperature sensors disposed on the packaging unit; and a transmission unit disposed on the packaging unit to transmit a result of measurement performed by the one or more temperature sensors to an external device.

### Advantageous Effects of Invention

The present disclosure, in an aspect thereof, is capable of acquiring information on the cold insulator.

### BRIEF DESCRIPTION OF DRAWINGS

FIG. 1 is a block diagram of a structure of a cold insulator management system in accordance with Embodiment 1.

FIG. 2 is a schematic view of a cold insulator included in the cold insulator management system.

FIG. 3 is a diagram of an exemplary data table containing temperature information stored in a memory unit.

FIG. 4 is a graph representing a relationship between the temperature of a cold storage material contained in the cold insulator and time.

FIG. 5 is a flow chart representing an exemplary flow of a process implemented in determining whether or not the cold insulator is available for use.

FIG. 6 is a flow chart representing an exemplary flow of a process implemented in estimating the refrigerated transportable time of the cold insulator.

FIG. 7 is a perspective view of an exemplary cold insulator that is another example of the cold insulator.

FIG. 8 is a block diagram of a structure of a cold insulator management system in accordance with Embodiment 2.

FIG. 9 is a flow chart representing an exemplary flow of a process implemented by the cold insulator management system.

FIG. 10 is a flow chart representing an exemplary flow of a process implemented when the cold insulator management system including a plurality of cold insulators determines whether or not one of the cold insulators is available for use.

FIG. 11 is a block diagram of a structure of a cold insulator management system.

FIG. 12 is a schematic view of a structure of a cold insulator.

FIG. 13 is a flow chart representing an exemplary process implemented by an information management device.

FIG. 14 is a schematic view of a structure of a cold insulator in accordance with Embodiment 4.

FIG. 15 is an enlarged view of a portion near a connection unit of a drawing shown in denotation 143 in FIG. 14.

FIG. 16 is a schematic view of a cold insulator in accordance with Embodiment 5.

FIG. 17 is an enlarged view of a portion near a connection unit of a drawing shown in denotation 162 in FIG. 16.

FIG. 18 is a block diagram of a structure of a freezer storage control system in accordance with Embodiment 6.

FIG. 19 is a flow chart representing an exemplary flow of a process implemented by a freezer storage control system.

### DESCRIPTION OF EMBODIMENTS

### Embodiment 1

Structure of Cold Insulator Management System 100

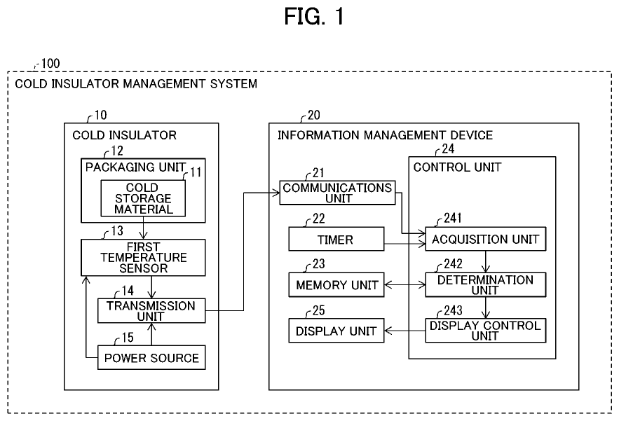

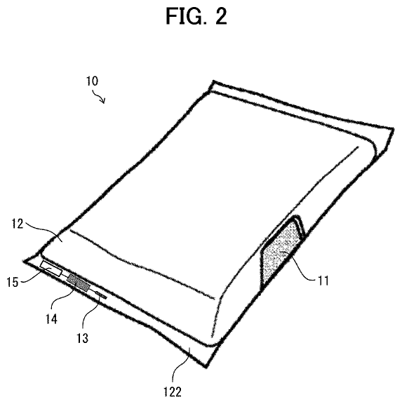

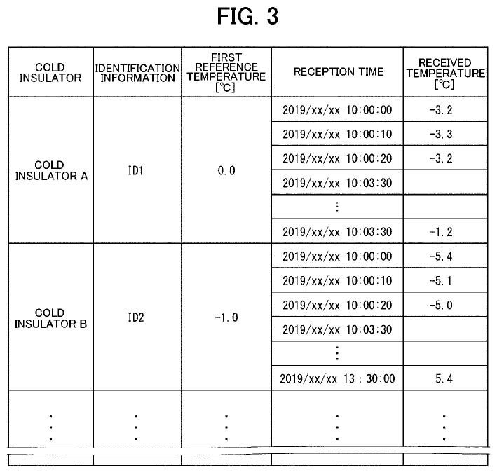

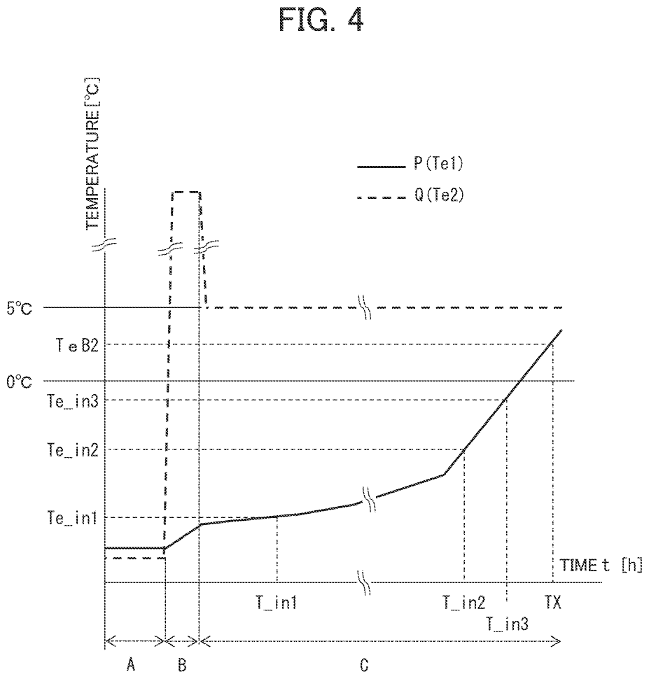

The following will describe an embodiment of the present disclosure in detail with reference to FIGS. 1 to 4. FIG. 1 is a block diagram of a structure of a cold insulator management system 100 in accordance with Embodiment FIG. 2 is a schematic view of a cold insulator 10 included in the cold insulator management system 100. FIG. 3 is a diagram of an exemplary data table containing temperature information stored in a memory unit 23. FIG. 4 is a graph representing a relationship between the temperature of a cold storage material 11 contained in the cold insulator 10 and time. Referring to FIG. 1, the cold insulator management system 100 in accordance with Embodiment 1 includes the cold insulator 10 and an information management device 20. The cold insulator management system 100 is a system for acquiring the temperature of the cold insulator 10 through the information management device 20 to determine and manage the condition of the cold insulator 10 on the basis of the temperature. The “condition of the cold insulator 10” refers to, for example, the temperature of the cold storage material 11 contained in the cold insulator 10, the availability or non-availability of the cold insulator 10 for use, and the refrigerated transportable time (detailed later) of the cold insulator 10.

### Structure of Cold Insulator 10

The following will describe a structure of the cold insulator 10 included in the cold insulator management system 100 with reference to FIGS. 1 and 2. The cold insulator 10 keeps an object to be kept cold X (not shown) at low temperature by being disposed near the object to be kept cold X. The “object to be kept cold X” is an article, such as fresh food, frozen food, or medical material, that may degrade in quality due to a rise in temperature. Specific examples of the object to be kept cold X include blood, vaccine, internal organs for transplant, chilled commercial goods, frozen food, fresh fish, dressed meat, and fresh produce. Referring to FIGS. 1 and 2, the cold insulator 10 includes at least one cold storage material 11, a packaging unit 12, a first temperature sensor 13, a transmission unit 14, and a power source 15. The transport of the object to be kept cold X from point of origin to destination while maintaining the temperature of the object to be kept cold X at or below 5° C. will be referred to as low temperature transport throughout the following description.

The cold storage material 11 is a coolant for keeping the object to be kept cold X at low temperature. The coolant used as the cold storage material 11 is not limited in any particular manner, and a coolant similar to a typical cold storage material may be used. For instance, a water-based or paraffin-based coolant may be used as the cold storage material 11.

The packaging unit 12 packages the cold storage material 11 in such a manner that the cold storage material 11 cannot leak out, for tight closure. The material for the packaging unit 12 is not limited in any particular manner, and a material used in a typical cold insulator may be used. As an example, materials publicly known in the field may be used as the material for the packaging unit 12. Specifically, for example, OPP (oriented polypropylene) or CPP (cast polypropylene) may be used as such a material. In addition, for example, polyolefin-based resin such as polyethylene, polyester-based resin such as ethylene-vinyl alcohol copolymer (EVOH) or polyethylene terephthalate, or polyvinylidene chloride (PVDC) may be used as such a material. Additionally, for example, a laminate packaging material that is a stack of a metal (e.g., aluminum) and other layers may be used as such a material.

The first temperature sensor 13 (temperature sensor) is a temperature sensor that detects the temperature of the cold storage material 11 or the temperature of the surroundings of the cold storage material 11. The first temperature sensor 13 may be disposed anywhere on the packaging unit 12, The first temperature sensor 13 in accordance with present Embodiment 1 is disposed on a part of a peripheral portion 122 of the packaging unit 12. The “peripheral portion 122 of the packaging unit 12” is, for example, the region where a laminate packaging material is closed for sealing after being wrapped around the cold storage material 11. The first temperature sensor 13 outputs, to the transmission unit 14, an output value representing the detected temperature Te1 of the cold storage material 11. Note that the number of the first temperature sensor 13 on a part of the peripheral portion 122 of the packaging unit 12 is not necessarily one, and there may be provided two or more first temperature sensors 13 on a part of the peripheral portion 122 of the packaging unit 12.

The transmission unit 14 is a communications module for wireless communications with the information management device 20. The transmission unit 14 is connected to the information management device 20 in a wirelessly communicable manner. The transmission unit 14 transmits a result of measurement of the temperature Te1 of the cold storage material 11 detected by the first temperature sensor 13 to the information management device 20 as temperature information.

In addition, the cold insulator 10 is assigned unique identification information. “Identification information” is information for distinguishing a cold insulator 10 from another cold insulator 10 and is, for example, a serial number for the cold insulator 10. The transmission unit 14 has the unique identification information and transmits the identification information together with the temperature information to the information management device 20, The identification information is, for example, stored in a built-in memory unit (not shown) in the transmission unit 14. Note that the memory unit may not be built in the transmission unit 14 and may be provided as a memory unit in the cold insulator 10 independently from the transmission unit 14.

The transmission unit 14 transmits the temperature information measured by the first temperature sensor 13 and the identification information to the information management device 20 by a communications method, for example, over Bluetooth®.

The transmission unit 14 is specifically a beacon terminal. If the cold insulator management system 100 includes two or more cold insulators 10, the transmission unit 14 of each cold insulator 10 transmits identification information, so that the information management device 20 can manage the locations of the cold insulators 10 and manage the temperature changes of each cold insulator 10.

The transmission unit 14 may transmit the temperature information or the identification information to the information management device 20 at intervals that can be suitably altered by the user. The interval may be, for example, specified from 1 ms to 100,000 ms.

The power source 15 is electrically connected to the first temperature sensor 13 and the transmission unit 14 to supply electric power to the first temperature sensor 13 and the transmission unit 14. The power source 15 is not limited in any particular manner, so long as the power source 15 is capable of supplying electric power to the first temperature sensor 13 and the transmission unit 14. The power source 15 may be a general battery, solar cell, or capacitor. Since the cold insulator 10 may be placed in a −5° C. or even colder environment, the power source 15 is more preferably capable of supplying electric power to the first temperature sensor 13 and the transmission unit 14 in such a low-temperature environment. If there is a possibility of the cold insulator 10 being placed in a −20° C. or even colder environment, the power source 15 is preferably, for example, an all-solid-state battery. Meanwhile, the power source 15 may be fed with electric power by radio power feed. In such a case, the power source 15 is electrically connected to a power feed reception circuit capable of radio power feed. The power feed reception circuit is made of a high electrical conductivity material such a copper, and for this reason provides an improved thermal transfer rate between the outside and the cold storage material 11.

Note that when the cold insulator management system 100 includes two or more cold insulators 10, each cold insulator 10 has the above-described structure and functions. For instance, the transmission unit 14 in each of the two or more cold insulators 10 transmits the temperature information measured by the first temperature sensor 13 in each of the two or more cold insulators 10 and the identification information of each cold insulator 10 to the information management device 20.

Structure of Information Management Device 20

The following will describe a structure of the information management device 20 included in the cold insulator management system 100 with reference to FIG. 1. Referring to FIG. 1, the information management device 20 includes a communications unit 21, a timer 22, the memory unit 23, a control unit 24, and a display unit 25. The information management device 20 may be provided, for example, in a truck that transports the cold insulator 10. Alternatively, the information management device 20 may be an information processing device independent from the truck, such as a smartphone, a computer, or a server.

The communications unit 21 is connected to the transmission unit 14 in the cold insulator 10 in a wirelessly communicable manner to receive temperature information from the transmission unit 14. Also, the communications unit 21 acquires ambient temperature information representing ambient temperature Te2. “Ambient temperature Te2” is the temperature acquired from a temperature sensor (not shown) provided in a freezer installed in a transport hub where the cold insulator 10 is stored or from a temperature sensor (not shown) provided in a refrigerated container on a transport vehicle that is transporting the cold insulator 10. The communications unit 21 outputs the acquired temperature information and ambient temperature information to the control unit 24.

The timer 22 acquires the current time. The timer 22 is, for example, a radio clock. The information management device 20 can acquire the current time through the timer 22. The memory unit 23 stores (i) the temperature information for the cold insulator 10 and the ambient temperature information both fed from an acquisition unit 241 and (ii) determination information, refrigerated transportable time information, and temperature change information all fed from a determination unit 242. The memory unit 23 also stores reference temperatures used by the determination unit 242 in the control unit 24 in making various determinations.

When the information management device 20 is connected to each of the two or more cold insulators 10 in a communicable manner, the memory unit 23 stores in advance the identification information (e.g., ID1, ID2) transmitted from the transmission unit 14 in each of the two or more cold insulators 10 (e.g., cold insulator A, cold insulator B) to the information management device 20 as shown in FIG. 3. The memory unit 23 also stores a first reference temperature TeB1 for each of the two or more cold insulators 10. The first reference temperature TeB1 is such a temperature that the temperature of the object to be kept cold X cannot be maintained at a prescribed refrigeration temperature by using the cold storage material 11 if the temperature of the cold storage material 11 rises to or exceeds the first reference temperature TeB1, and is a cold storage reference temperature for the object to be kept cold X. The first reference temperature TeB1 may be specified by the user in a suitable manner, depending on, for example, the composition of the cold storage material 11 in each cold insulator 10 or the type of the object to be kept cold X in each cold insulator 10. The memory unit 23 stores the temperature information transmitted from the transmission unit 14 in each of the two or more cold insulators 10 to the information management device 20 (the temperature information corresponds to “RECEIVED TEMPERATURE” in FIG. 3) in association with a reception time at which the temperature information is received and also in association with the identification information of each cold insulator 10. In this manner, the memory unit 23 stores the identification information and the temperature information in association for each cold insulator 10.

The control unit 24 includes the acquisition unit 241, the determination unit 242, and a display control unit 243. The acquisition unit 241 acquires the temperature information and the ambient temperature information through the communications unit 21 for output to the determination unit 242. The acquisition unit 241 also outputs the temperature information and the ambient temperature information to the memory unit 23.

The determination unit 242 refers to the various reference values stored in the memory unit 23 to make various determinations in relation to the cold insulator 10 on the basis of the acquired temperature information and ambient temperature information. For instance, the determination unit 242 determines whether or not the cold insulator 10 is available for use. Specifically the determination unit 242, upon acquiring the temperature information, refers to the memory unit 23 to acquire the first reference temperature TeB1. The determination unit 242 compares the temperature Te1 of the cold storage material 11 with the first reference temperature TeB1. If the temperature Te1 of the cold storage material 11 is higher than or equal to the first reference temperature TeB1, the determination unit 242 determines that the cold insulator 10, containing the cold storage material 11, is not available for use. On the other hand, if the temperature Te1 of the cold storage material is lower than the first reference temperature TeB1, the determination unit 242 determines that the cold insulator 10, containing the cold storage material 11, is available for use. The determination unit 242 outputs this result of determination to the display control unit 243 as availability information.

In addition, if a transport vehicle, such as a truck, equipped with a refrigerated container is currently transporting the cold insulator 10 at low temperature, the determination unit 242 estimates the time over which the temperature of the cold storage material 11 can be maintained at or below a prescribed temperature. This “time over which the temperature of the cold storage material 11 can be maintained at or below a prescribed temperature” will be referred to as the “refrigerated transportable time” throughout the following description. Within the refrigerated transportable time, the temperature of the object X to be kept at low temperature by the cold insulator 10 is maintained at or below a temperature at which the object to be kept cold X does not degrade in quality. This estimation process is now described with reference to FIG. 4. In FIG. 4, the line denoted by P represents the temperature Te1 of the cold storage material, and the line denoted by Q represents ambient temperature Tet. Also in FIG. 4, the period indicated by arrow A is a period over which the cold insulator 10 is stored in a freezer storage for storing the cold insulator 10 in frozen state, the period indicated by arrow B is a period over which the cold insulator 10 is taken out of the freezer storage and placed in contact with open air, and the period indicated by arrow C is a period over which the cold insulator 10 is placed inside a refrigerated container of a transport vehicle for the transport of the object to be kept cold X while maintaining the object to be kept cold X at low temperature.

The determination unit 242 acquires the temperature of the cold storage material 11 at prescribed intervals. For instance, the determination unit 242 acquires the temperature of the cold storage material 11 (Te_in1, Te_in2, and Te_in3) at times labeled T_in1, T_in2, and T_in3 in FIG. 4. Subsequently, the determination unit 242 refers to the memory unit 23 to acquire a second reference temperature TeB2. The second reference temperature TeB2 is such a temperature that the cold storage material 11 fails to deliver the functions thereof when the temperature Te1 of the cold storage material 11 is higher than or equal to the second reference temperature TeB2. The determination unit 242 predicts time TX at which the temperature Te1 of the cold storage material 11 reaches the second reference temperature TeB2, by extrapolation or another like calculation technique on the basis of temporal variations in the temperature Te1 of the cold storage material 11 acquired multiple times. The determination unit 242 outputs a result of the prediction to the display control unit 243 as the refrigerated transportable time information. The determination unit 242 outputs the refrigerated transportable time information also to the memory unit 23.

in addition, the determination unit 242 calculates changes in the temperature Te1 of the cold storage material 11 on the basis of the acquired temperature information and the temperature information contained in the memory unit 23. For instance, the determination unit 242 compares temperature information for 30 minutes ago with current temperature information. The determination unit 242 outputs the calculated temperature changes of the cold storage material 11 to the display control unit 243 as temperature change information.

The display control unit 243 acquires (i) the temperature information from the acquisition unit 241 and (ii) the availability information, refrigerated transportable time information, or temperature change information from the determination unit 242, to enable the display unit 25 to display information on the cold insulator 10. The information on the cold insulator 10 displayed on the display unit 25 includes, for example, (i) the current temperature of the cold insulator 10, (ii) the difference between the temperature of the cold insulator 10 a prescribed time (e.g., 30 minutes) prior to the current time and the current temperature of the cold insulator 10, (iii) the availability of the cold insulator 10 for use, and (iv) the refrigerated transportable time.

The display unit 25 is a display device for displaying the condition of the cold insulator 10 under control of the display control unit 243. The display unit 25 may be, for example, a liquid crystal panel or a lamp.

### Exemplary Flow of Process by Cold Insulator Management System 100

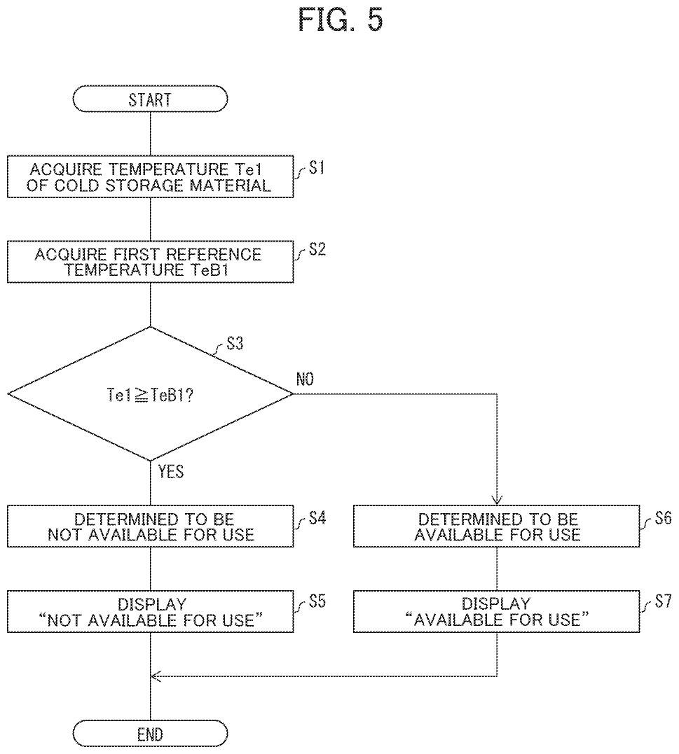

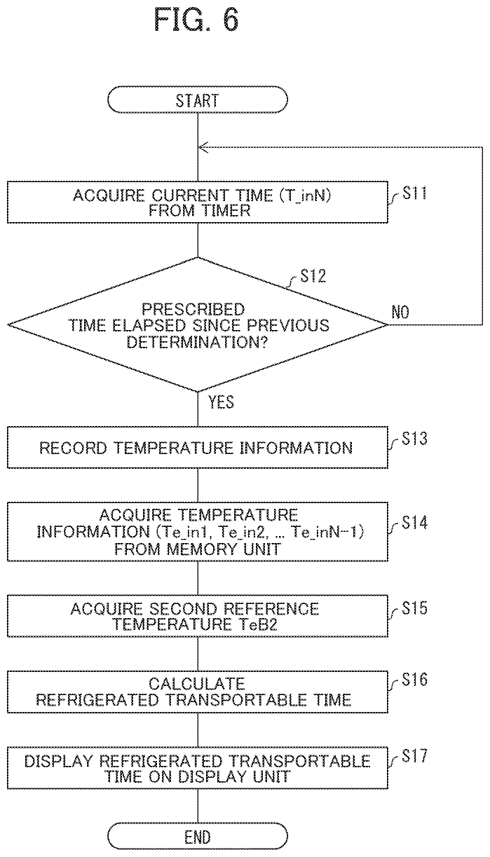

The following will describe an exemplary flow of a process implemented by the cold insulator management system 100 in accordance with Embodiment 1 with reference to FIGS. 5 and 6. FIG. 5 is a flow chart representing an exemplary flow of a process implemented in determining whether or not the cold insulator 10 is available for use. FIG. 6 is a flow chart representing an exemplary flow of a process implemented in estimating the refrigerated transportable time of the cold insulator 10.

### Determining Availability for Use

A description is given first of an exemplary flow of a process implemented in determining whether or not the cold insulator 10 is available for use, with reference to FIG. 5. First of all, the acquisition unit 241 acquires the temperature Te1 of the cold storage material 11 from the cold insulator 10 (S1) for output to the determination unit 242 as temperature information. The determination unit 242, upon acquiring the temperature information, refers to the memory unit 23 to acquire the first reference temperature TeB1 (S2). Next, the determination unit 242 compares the temperature Te1 of the cold storage material 11 with the first reference temperature TeB1 (S3).

If the Temperature Te1 of Cold Storage Material 11 ≥First Reference Temperature TeB1 (YES in step S3), the determination unit 242 determines that the cold insulator 10 is not available for use (S4) and outputs this result of determination to the display control unit 243 as availability information. The display control unit 243, upon acquiring the availability information, controls the display unit 25 to display to the effect that the cold insulator 10 is not available for use (S5).

On the other hand, if the Temperature Te1 of Cold Storage Material 11 <First Reference Temperature TeB1 (NO in step S3), the determination unit 242 determines that the cold insulator 10 is available for use (S6) and outputs this result of determination to the display control unit 243 as availability information. The display control unit 243, upon acquiring the availability information, controls the display unit 25 to display to the effect that the cold insulator 10 is available for use (S7).

### Variation Examples of Determining Availability for Use

When the cold insulator management system 100 includes two or more cold insulators 10, the determination unit 242 may identify any available cold insulator(s) 10 out of the two or more cold insulators 10. Specifically, the determination unit 242 refers to the memory unit 23 to acquire the identification information and temperature information for a reception time that are stored in association for each cold insulator 10. The determination unit 242 also refers to the memory unit 23 to acquire the first reference temperature Te131 stored in association with each piece of identification information. Subsequently, the determination unit 242 determines whether or not each cold insulator 10 is available for use. The determination unit 242 outputs a result of the determination as to whether or not each cold insulator 10 is available for use to the display control unit 243 as availability information. The display control unit 243, upon acquiring the availability information, controls the display unit 25 to display, for each cold insulator 10, to the effect that the cold insulator 10 is not available for use or to the effect that the cold insulator 10 is available for use.

### Estimating Refrigerated Transportable Time

A description is given next of an exemplary flow of a process implemented in estimating the refrigerated transportable time of the cold insulator 10 being transported at low temperature, with reference to FIG. 6. The acquisition unit 241 first acquires temperature information from the transmission unit 14 of the cold insulator 10 and acquires ambient temperature information on the ambient air inside the refrigerated container from a temperature sensor provided inside the refrigerated container for output to the determination unit 242. The determination unit 242, upon acquiring the temperature information and the ambient temperature information on the ambient air inside the refrigerated container, acquires a time at which a determination was made previously on refrigerated transportable time from the memory unit 23 and also acquires the current time T ins from the timer 22 (S11).

Next, the determination unit 242 determines whether or not a prescribed time (e.g., 1 minute) has elapsed since the previous determination on refrigerated transportable time (S12). The previous determination on refrigerated transportable time (YES in step S12), the determination unit 242 records the acquire temperature information and ambient temperature information together with the current time in the memory unit 23 (S13). On the other hand, if the prescribed time has elapsed since the previous determination on refrigerated transportable time (NO in step S12), the process returns to step S11.

Subsequent to S13, the determination unit 242 refers to the memory unit 23 to acquire temperature information (Te_in1, Te_in2, . . . Te_inN-1) recorded from a point in time T_in1 at which the low temperature transport was started to the previous time T_inN-1 (514). The determination unit 242 also refers to the memory unit 23 to acquire the second reference temperature TeB2 (S15).

Subsequently, the determination unit 242 calculates time TX taken by the temperature Te1 of the cold storage material 11 to reach the second reference temperature TeB2 starting at the current time, by extrapolation or another like calculation technique on the basis of the acquired temperature information (S16). The determination unit 242, upon calculating time TX, outputs the result of calculation to the display control unit 243 as refrigerated transportable time information. The display control unit 243, upon acquiring the refrigerated transportable time information, controls the display unit 25 to display the refrigerated transportable time as the time over which the cold insulator 10 can be transported at low temperature (S17).

### Effects of Cold Insulator 10

The cold insulator 10 of the cold insulator management system 100 in accordance with Embodiment 1 includes: at least one cold storage material 11; the first temperature sensor 13 for measuring the temperature Te1 of the cold storage material 11; and the transmission unit 14, disposed in the packaging unit 12, for transmitting a result of measurement made by the first temperature sensor 13 to the information management device 20 which is an external device (external device to the cold insulator 10).

This structure enables the cold insulator 10 to transmit the temperature Te1 of the cold storage material 11 itself contained in the cold insulator 10 to the information management device 20. The structure hence enables managing the condition of the cold insulator 10 by using the information management device 20.

### Effects Cold Insulator Management System 100

The cold insulator management system 100 in accordance with Embodiment 1 includes the cold insulator 10 and the information management device 20. By the information management device 20 acquiring the temperature Te1 of the cold storage material 11 contained in the cold insulator 10, the condition of the cold insulator 10 (e.g., availability for use, refrigerated transportable time, and temperature change) can be determined.

The cold insulator management system 100 is applicable to a cold logistic system for low temperature transport. By providing the control unit 24 of the information management device 20 as a management server at a point of origin and a destination and also providing the display unit 25 on a transport vehicle, such as a truck, for transporting the object to be kept cold X, it becomes possible to present the condition of the cold insulator 10 to a user who is a manager of the cold insulator 10 via the display unit 25.

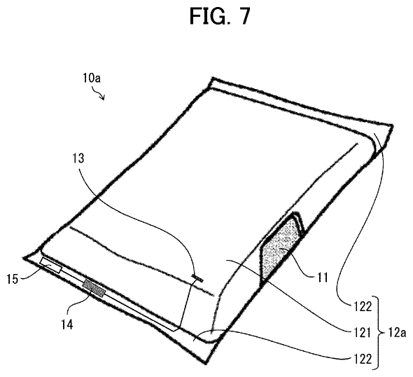

Variation Examples FIG. 7 is a perspective view of an exemplary cold insulator 10a that is another example of the cold insulator 10. Referring to FIG. 7, in the cold insulator 10a, a packaging unit 12a includes (i) a main portion 121 for packaging the cold storage material 11 and (ii) the peripheral portion 122 provided along the periphery of the main portion 121. In addition, the first temperature sensor 13 is disposed on the main portion 121 of the packaging unit 12 (specifically, on a part of the packaging unit 12 in a location that overlaps the cold storage material 11), In such a case, the first temperature sensor 13 is capable of more precise measurement of the temperature of the cold storage material 11. Therefore, the information management device 20 is capable of more precise management of the temperature or condition of the cold insulator 10. Note that the number of the first temperature sensor 13, disposed on a part of the packaging unit 12 in a location that overlaps the cold storage material 11, is not necessarily one, and there may be provided two or more first temperature sensors 13 each on a part of the packaging unit 12 in a location that overlaps the cold storage material 11.

In the cold insulator 10a, the main portion 121 of the packaging unit 12 may have a three-dimensional shape with a plurality of faces such as a substantially rectangular parallelepiped shape, a substantially cylindrical shape, or a substantially elliptical cylinder shape. FIG. 7 shows an example where the main portion 121 has a substantially rectangular parallelepiped shape.

When the main portion 121 has one of these three-dimensional shapes, the first temperature sensor 13 may be disposed on one of the plurality of faces that has the largest area. The cold storage material 11 packaged in the packaging unit 12 is located closest to, or in contact with, this one of the plurality of faces that has the largest area. Therefore, the first temperature sensor 13, when disposed on the face that is the largest in area, can more precisely measure the temperature the cold storage material 11.

### Embodiment 2

### Structure of Cold Insulator Management System 100a

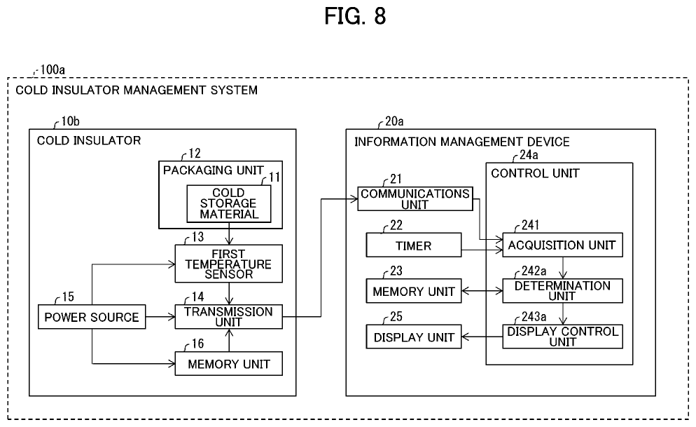

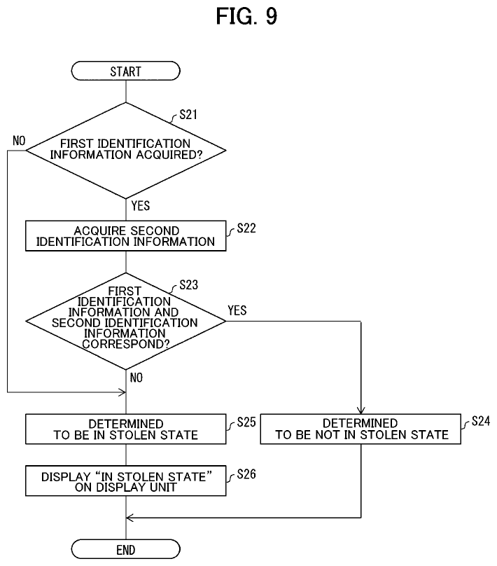

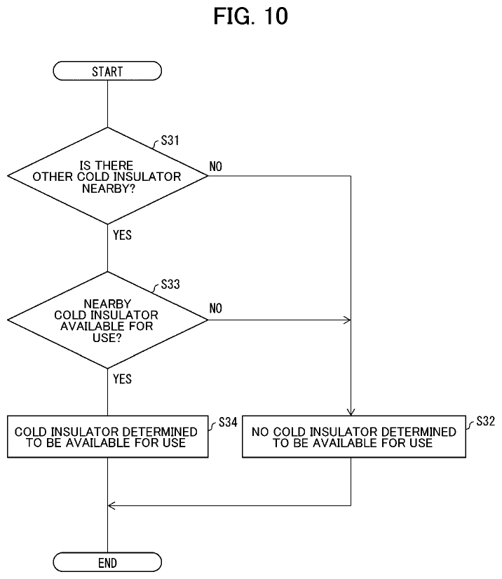

The following will describe another embodiment of the present disclosure with reference to FIGS. 8 to 10. FIG. 8 is a block diagram of a structure of a cold insulator management system 100a in accordance with Embodiment 2. FIG. 9 is a flow chart representing an exemplary flow of a process implemented by the cold insulator management system 100a in accordance with Embodiment 2. FIG. 10 is a flow chart representing an exemplary flow of a process implemented when the cold insulator management system 100a including a plurality of cold insulators 10b determines whether or not one cold insulator 10bx is available for use.

Referring to FIG. 8, the cold insulator management system 100a in accordance with Embodiment 2 includes a cold insulator 10b and an information management device 20a. The cold insulator 10b differs from the cold insulator 10 in that the cold insulator 10b includes a memory unit 16. The memory unit 16 stores first identification information. The first identification information is an example of identification information for identifying the cold insulator 10b, The cold insulator 10b transmits the first identification information together with temperature information to the information management device 20a. When there is provided a plurality of cold insulators 10b, the memory unit 16 included in each cold insulator 10b contains different first identification information. The cold insulator management system 100a implements management based on the first identification information and second identification information as well as the management that the cold insulator management system 100 implements based on temperature.

The information management device 20a differs from the information management device 20 in that the information management device 20a includes a control unit 24a in place of the control unit 24. Note that similarly to the information management device 20, the information management devices 20a to 20c (detailed later) are also external devices. The control unit 24a differs from the control unit 24 in that the control unit 24a includes a determination unit 242a and a display control unit 243a in place of the determination unit 242. In addition, the memory unit 23 in the information management device 20a contains the second identification information which is identification information corresponding to the first identification information for the cold insulator 10b.

When the cold insulator management system 100a includes a plurality of cold insulators 10b, the determination unit 242a makes, for each cold insulator 10b, the determination based on temperature described in Embodiment 1 and the determination based on the first identification information and the second identification information described in the present embodiment. In addition, the display control unit 243a controls the display unit 25 to display a result of the determinations made for each cold insulator 10b.

The determination unit 242a also determines whether or not the cold insulator 10b is in stolen state based on the first identification information for the cold insulator 10b. Specifically, the determination unit 242a, upon acquiring the first identification information from the cold insulator 10b, collates the acquired, first identification information with the second identification information which is identification information corresponding to the first identification information stored in the memory unit 23. If the first identification information does not match the second identification information, the determination unit 242a determines that the cold insulator 110b is in stolen state. On the other hand, if the first identification information matches the second identification information, the determination unit 242a determines that the cold insulator 10b is not in stolen state.

In addition, the determination unit 242a implements this determination at prescribed intervals. If the first identification information cannot be acquired at the prescribed intervals, the determination unit 242a determines that the cold insulator 10b is in stolen state. If the cold insulator 10b is determined to be in stolen state, the determination unit 242a outputs this result of determination as stealing information to the display control unit 243a. The display control unit 243a, upon acquiring the stealing information, controls the display unit 25 to display to the effect that the cold insulator 10b is in stolen state. Note that if the cold insulator 10b is determined to not be in stolen state, the determination unit 242a may output this result of determination as non-stealing information to the display control unit 243a. In such a case, the display control unit 243a controls the display unit 25 to display to the effect that the cold insulator 10b is not in stolen state.

Exemplary Flow of Process by Cold Insulator Management System 100a The following wilt describe an exemplary flow of a process implemented by the cold insulator management system 100a with reference to FIG. 9. Note that this process may be implemented at prescribed intervals (e.g., every 1 minute) or implemented by a user at any time.

First, the determination unit 242a determines whether or not the first identification information for the cold insulator 10b has been acquired (S21). If the determination unit 242a has acquired the first identification information for the cold insulator 10b (YES in step S21), the determination unit 242a refers to the memory unit 23 to acquire the second identification information corresponding to the first identification information for the cold insulator 10b (S22). Subsequently, the determination unit 242a collates the first identification information and the second identification information to determine whether or not the first identification information and the second identification information correspond (S23). If the first identification information and the second identification information correspond (YES in step S23), the determination unit 242a determines that the cold insulator 10b is not in stolen state (S24), thereby terminating the process.

On the other hand, if the first identification information and the second identification information do not correspond (NO in step S23), in other words, if the acquired identification information differs from the first identification information for the cold insulator 10b on which a determination is to be made, the determination unit 242a determines that the cold insulator 10b is in stolen state (S25) and outputs this result of determination as stealing information to the display control unit 243a.

Meanwhile, if the determination unit 242a has not acquired the first identification information for the cold insulator 10b (NO in step S21), the determination unit 242a likewise determines that the cold insulator 10b is in stolen state (S25) and outputs this result of determination as stealing information to the display control unit 243a. The display control unit 243a, upon acquiring the stealing information, controls the display unit 25 to display to the effect that the cold insulator 10b is in stolen state (S26).

### Effects of Cold Insulator(s) 10b

The cold insulator 10b in accordance with Embodiment 2 stores the first identification information (identification information) in the memory unit 16 and outputs the first identification information together with temperature information to the information management device 20. This configuration enables the information management device 20 to identify and manage the plurality of cold insulators 10b.

### Effects of Cold Insulator Management System 100a

The cold insulator management system 100a includes the information management device 20a. If the cold insulator 10b is not present in a prescribed location or has been stolen or if there is a cold insulator other than the cold insulator 10b in a location where the cold insulator 10b should be, the determination unit 242a in the information management device 20a determines that the cold insulator 10b is in stolen state. This configuration enables determining whether or not the cold insulator 10b included in the cold insulator management system 100a is in stolen state.

### Variation Examples

The cold insulator 10b in accordance with Embodiment 2 may include a location information acquisition unit for acquiring the current location of the cold insulator 10b, in such a case, the cold insulator 10b transmits the location information representing the current location of the cold insulator 10b together with temperature information to the information management device 20a. The location information may be acquired by using, for example, the UPS (global positioning system).

The information management device 20a, upon acquiring the location information together with the temperature information from the cold insulator 10b, may calculate a third reference temperature TeB3 on the basis of the location information. The third reference temperature TeB3 is the temperature of the cold storage material 11 at which the object to be kept cold X can be transported at or below desirable temperature to the destination. Specifically, first, a transport route of the cold insulator 10b is recorded in the memory unit 23 in advance. The determination unit 242, in acquiring the temperature information from the cold insulator 10b, concurrently acquires the location information of the cold insulator 10b. Subsequently, the determination unit 242a refers to the memory unit 23 to acquire the transport route of the cold insulator 10b. The determination unit 242a calculates travel time TY for the cold insulator 10b to arrive at the destination, from the acquired location information and transport route of the cold insulator 10b. The determination unit 242a calculates the third reference temperature TeB3 on the basis of calculated travel time TY. Thereafter, the determination unit 242a makes a determination similar to the determination described in Embodiment 1 with reference to FIG. 5 as to whether or not the cold insulator 10 is available for use by using the third reference temperature TeB3 in place of the second reference temperature TeB2.

A description is now given of a case where the cold insulator management system 100a includes a plurality of cold insulators 10b, and the cold insulator 10bx, which is the cold insulator 10b on which a determination has been made as to the availability thereof, is not available for use in low temperature transport. In this case, the determination unit 242a determines whether or not there is another cold insulator 10by available among the cold insulators 10b included in the cold insulator management system 100a.

The following will describe another exemplary flow of a process implemented by the cold insulator management system 100a with reference to FIG. 10. First, the determination unit 242a, upon determining that one cold insulator 10bx is not available for use, determines whether or not there is another cold insulator 10b near the cold insulator 10bx, for example, in the same hub (S31). If there is no cold insulator 10b other than the cold insulator 10bx near the cold insulator 10bx (NO in step S31), the determination unit 242a determines that there is no cold insulator 10by available (532), thereby terminating this process.

On the other hand, if there is a cold insulator 10b other than the cold insulator 10bx near the cold insulator 10bx (YES in step S31), the determination unit 242a determines whether or not the nearby cold insulator 10b is available for use (S33). If there is no cold insulator available among the nearby cold insulators 10b (NO in step S33), the determination unit 242a terminates the process.

On the other hand, if there is a cold insulator available among the nearby cold insulators 10b (YES in step S33), the determination unit 242a determines that there is a cold insulator 10by that can be used in place of the cold insulator 10bx (534) and outputs this result of determination to the display control unit 243a. The display control unit 243a, upon acquiring the result of determination, controls the display unit 25 to display to the effect that there is a cold insulator 10by that is the cold insulator 10b that can be used in place of the cold insulator 10bx.

### Embodiment 3

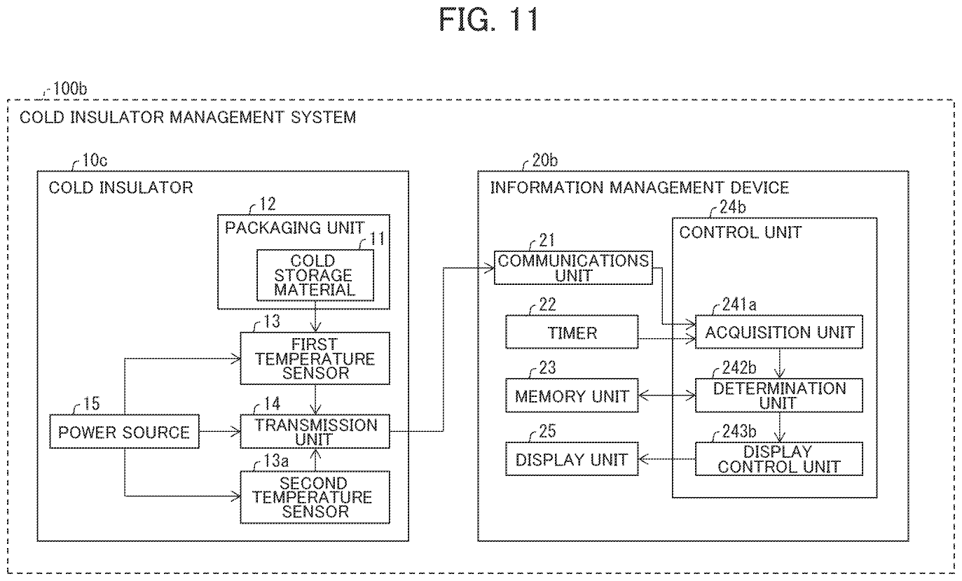

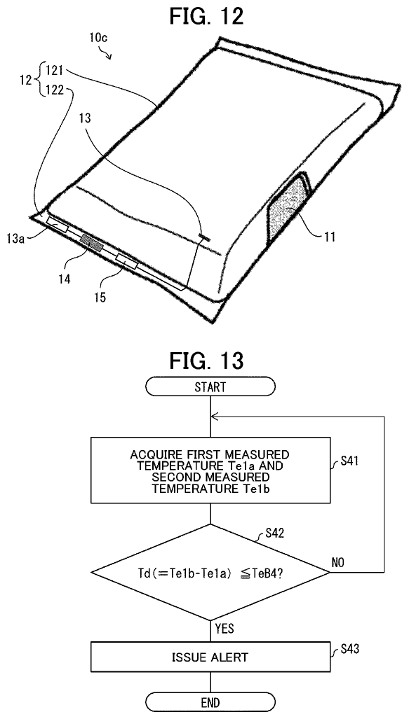

Structure of Cold Insulator Management System 100b The following will describe another embodiment of the present disclosure with reference to Ms. 11 to 13. FIG. 11 is a block diagram of a structure of a cold insulator management system 100b in accordance with Embodiment 3. FIG. 12 is a schematic view of a structure of a cold insulator 10c included in the cold insulator management system 100b. FIG. 13 is a flow chart representing an exemplary process implemented by an information management device 20b included in the cold insulator management system 100b.

Referring to FIG. 11, the cold insulator management system 100b in accordance with Embodiment 3 includes the cold insulator 10c and the information management device 20b. In the present embodiment, the cold insulator management system 100b more precisely manages the temperature and condition of the cold storage material 11 contained in the cold insulator 10.

### Structure of Cold Insulator 10c

The following will describe a structure of the cold insulator 10c. Referring to FIGS. 11 and 12, the cold insulator 10c in accordance with. Embodiment 3 differs from the cold insulator 10a in accordance with Embodiment 1 in that the cold insulator 10c includes a second temperature sensor 13a (temperature sensor) as well as the first temperature sensor 13. The second temperature sensor 13a measures the temperature of the surroundings (i.e., ambient temperature Te2) of the cold storage material 11. The result of measurement made by the second temperature sensor 13a is, similarly to the result of measurement made by the first temperature sensor 13, transmitted to the information management device 20b by the transmission unit 14.

In Embodiment 3, the first temperature sensor 13 is disposed on the main portion 121 of the packaging unit 12 (specifically, in a location that overlaps the cold storage material 11). The second temperature sensor 13a is disposed on a part of the peripheral portion 122. Therefore, in present Embodiment 3, in the cold insulator 10c, by each of the plurality of temperature sensors (the first temperature sensor 13 and a second temperature sensor 13c) measuring temperature, the information management device 20b can determine a temperature distribution in the cold insulator 10c. Therefore, the information management device 20b is capable of more precisely managing the temperature or condition of the cold insulator 10c and the cold storage material 11 by using the temperature information representing the temperature (Te1) measured by the first temperature sensor 13 and the temperature information representing the ambient temperature (Te2) measured by the second temperature sensor 13c.

Note that the cold insulator 10c may include a temperature sensor other than the first temperature sensor 13 and the second temperature sensor 13a. In addition, this temperature sensor may be disposed in a location outside the peripheral portion 122 other than a part of the packaging unit 12 in a location that overlaps the cold storage material 11 (e.g., on a part of the main portion 121 in a location that does not overlap the cold storage material 11). Also, there may be provided two or more first temperature sensors 13 in a location that overlaps the cold storage material 11. Likewise, there may be provided two or more second temperature sensors 13a on the peripheral portion 122.

In the cold insulator 10c, there may be specified as many pieces of identification information as the number of the temperature sensors (the first temperature sensor 13 and the second temperature sensor 13c) in the cold insulator 10c. The identification information may, as described earlier, be stored in a built-in memory unit in the transmission unit 14 or stored in a memory unit provided independently from the transmission unit 14.

### Structure of Information Management Device 20h

Referring to FIG. 11, the information management device 20b in accordance with Embodiment 3 differs from the information management device 20 in accordance with Embodiment 1 in that the information management device 20b includes an acquisition unit 241a, a determination unit 242b, and a display control unit 243b in place of the acquisition unit 241, the determination unit 242, and the display control unit 243. The acquisition unit 241a acquires the temperature information measured by the first temperature sensor 13 and the second temperature sensor 13c from the transmission unit 14 in the cold insulator 10c for output to the determination unit 242b. The determination unit 242h determines whether or not the cold insulator 10c is available for use on the basis of the acquired temperature information. If the cold insulator 10c is not available for use, the determination unit 242b outputs this result of determination to the display control unit 243b. The display control unit 243b, upon acquiring the result of determination, controls the display unit 25 to display to the effect that the cold insulator 10c is not available for use as an alert.

### Exemplary Process by Information Management Device 20b

The following will describe an exemplary management of the condition of the cold insulator 10 based on results of measurement made by the first temperature sensor 13 and the second temperature sensor 13a with reference to FIG. 13. Referring to FIG. 13, in the information management device 20b, the acquisition unit 241a (see FIG. 11) of a control unit 24b acquires a first measured temperature Te1a measured by the first temperature sensor 13 (result of measurement made by the first temperature sensor 13) and a second measured temperature Te1b measured by the second temperature sensor 13a (result of measurement made by the second temperature sensor 13a) (S41).

In Embodiment 3, the determination unit 242b determines whether or not the cold storage material 11 may possibly not perform the function thereof due to a rise in the temperature Te1 of the cold storage material 11. The determination unit 242b subtracts the received, first measured temperature Te1a from the received, second measured temperature Te1b to calculate a temperature difference Td therebetween. The determination unit 242b then compares the temperature difference Td with a fourth reference temperature TeB4 stored in advance in the memory unit 23. Specifically, the determination unit 242b determines whether or not the temperature difference Td is smaller than or equal to the fourth reference temperature TeB4 (S42).

The fourth reference temperature TeB4 is set through, for example, experiments to a maximum value of the temperature difference Td at which the cold storage material 11 no longer performs the function thereof. The fourth reference temperature TeB4 may be set taking into account the relative relationship between the melting point temperature of the cold storage material 11 and ambient temperature Tet in the vicinity of the cold storage material 11. For instance, when it is expected that the melting point temperature of the cold storage material 11 is 3° C., and that ambient temperature Tet in the vicinity of the cold storage material 11 is 40° C., the fourth reference temperature TeB4 is set to, for example, 30° C.

If the temperature difference Td is determined to be smaller than or equal to the fourth reference temperature TeB4 (YES in step S42), the determination unit 242b determines that the cold insulator 10b is not available for use and outputs this result of determination to the display control unit 243b. The display control unit 243b, upon acquiring the result of determination, controls the display unit 25 to display to the effect that the cold insulator 10c is not available for use. For instance, the display control unit 243b displays on the display unit 25 an alert to the effect that the cold storage material 11 may possibly not perform the function thereof due to a rise in the temperature of the cold storage material 11 (S43).

On the other hand, if the temperature difference Td is determined to exceed the fourth reference temperature TeB4 (NO in step S42), the determination unit 242b determines that the cold insulator 10c is available for use. Then, the process returns to step S41.

In this manner, the control unit 24b alerts the user of the information management device 20b (e.g., manager of the cold insulator 10c) on the basis of the temperature difference Td to the effect that the cold insulator 10c is not available for use. As described above, in the cold insulator 10c, since it is possible to precisely measure the first measured temperature Te1a and the second measured temperature Tell), the information management device 20b can precisely issue the alert described above.

Note that the first measured temperature Te1a and the second measured temperature Te1b are continuously measured and acquired at prescribed intervals. If it is determined that Td>TeB4 on the basis of the first measured temperature Te1a and the second measured temperature Te1b acquired after issuing the alert, the control unit 24b may stop the alert.

### Other Exemplary Process by Information Management Device 20b

Similarly to Embodiment 1, the control unit 24b may estimate refrigerated transportable time. In Embodiment 1, the control unit 24b acquires ambient temperature Tet from a temperature sensor (not shown) provided in a freezer in the hub where the cold insulator 10c is stored or a temperature sensor provided in the refrigerated container of the transport vehicle transporting the cold insulator 10c. In the present embodiment, the control unit 24b acquires the second measured temperature Te1b from the second temperature sensor 13a in place of these temperature sensors. Therefore, the control unit 24b can precisely estimate refrigerated transportable time by taking into account the temperature distribution in the cold insulator 10c based on the results of measurement made by a plurality of temperature sensors.

This prediction enables lowering the possibility of degradation of the object to be kept cold X caused by a rise in the temperature of the object to be kept cold X for the cold insulator 10c similarly to Embodiment 1. Particularly, in the present embodiment, the control unit 24b can precisely estimate refrigerated transportable time, therefore further lowering the possibility of degradation of the object to be kept cold. X.

### Embodiment 4

### Structure of Cold Insulator 10d

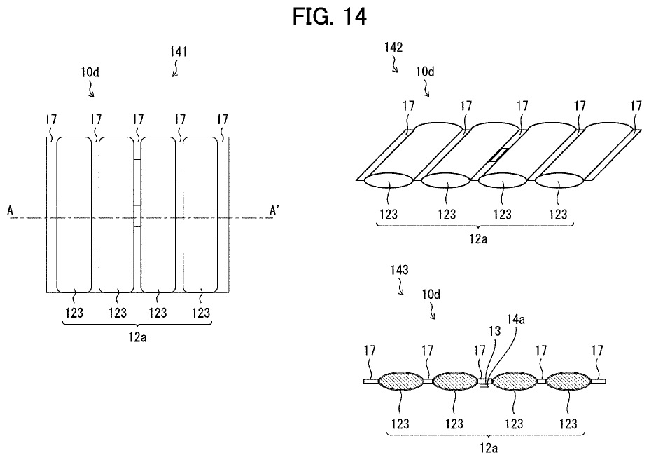

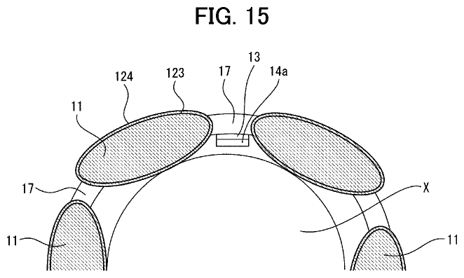

The following will describe Embodiment 4 of the present disclosure with reference to FIGS. 14 and 15. FIG. 14 is a schematic view of a structure of a cold insulator 10d in accordance with Embodiment 4. The drawing shown in denotation 141 in FIG. 14 is a front view of the cold insulator 10d. The drawing shown in denotation 142 in FIG. 14 is a perspective view of the cold insulator 10d. The drawing shown in denotation 143 in FIG. 14 is a cross-sectional view showing a cross-section taken along break line A-A′ in the drawing shown in denotation 141. FIG. 15 is an enlarged view of a portion near a connection unit 17 of a drawing shown in denotation 143 in FIG. 14.

Referring to FIGS. 14 and 15, the cold insulator 10d is a cold insulator of a “film-packed” type. The user keeps the object to be kept cold X at low temperature by winding the cold insulator 10d around the object to be kept cold X. The cold insulator 10d differs from the cold insulator 10 in accordance with Embodiment 1 in that the cold insulator 10d includes a plurality of cold storage materials 11, a packaging unit 12a, a transmission unit 14a, and the connection unit 17. The packaging unit 12a includes a plurality of packaging areas 123. Each packaging area 123 packages one of the cold storage materials 11. The connection unit 17 closes gaps between the packaging areas 123. The connection unit 17 may be made of the same material as the packaging unit 12a or of a different material from the packaging unit 12a. As an example, each packaging area 123 has a cylindrical shape with an elliptical cross-section taken perpendicular to the major axial direction. The first temperature sensor 13 and the transmission unit 14a are disposed on a part of the connection unit 17.

If the cold storage materials 11 are a water-based coolant, each packaging area 123 is preferably covered with a metal coating film 124 (metal) as shown in FIG. 15, The metal coating film 124 is preferably shaped like a thin foil of metal with a high thermal conductivity. Alternatively, the cold storage materials 11 are preferably a paraffin-based coolant.

Effects of Cold Insulator 10d When the cold storage materials 11 are a water-based coolant, the radio waves emanating in the direction of the cold storage materials 11 out of the radio waves emanating from the transmission unit 14a for Bluetooth communications are mostly absorbed by the cold storage materials 11.

Here, each packaging area 123 of the cold insulator 10d is covered with the metal coating film 124. Since the radio waves emanating from the transmission unit 14 are reflected by the metal coating film 124, it is possible to reduce the possibility of the radio waves being absorbed by the cold storage materials 11. Furthermore, since the cold insulator 10d is a film-packed cold insulator, the radio waves are reflected between the plurality of packaging areas 123 and also between the packaging areas 123 and the object to be kept cold X and travel toward the communications unit 21 of the information management device 20. This structure can reduce the loss of the radio waves emanating from the transmission unit 14a.

Note that the paraffin-based coolant has a lower absorptance of radio waves than the water-based coolant. Therefore, when the cold storage materials 11 are a paraffin-based coolant, the loss of the radio waves emanating from the transmission unit 14a can be reduced without having to cover each packaging area 123 with the metal coating film 124.

### Embodiment 5

### Structure of Cold Insulator 10e

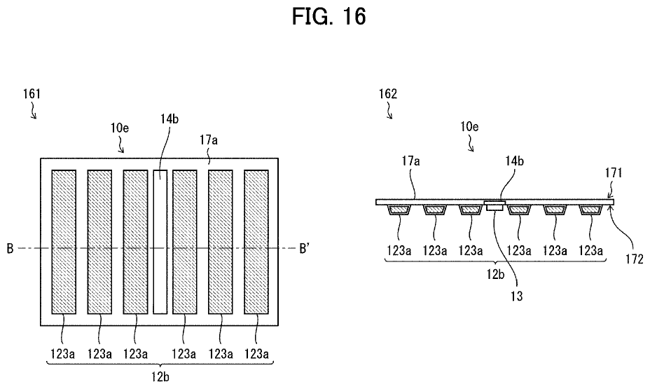

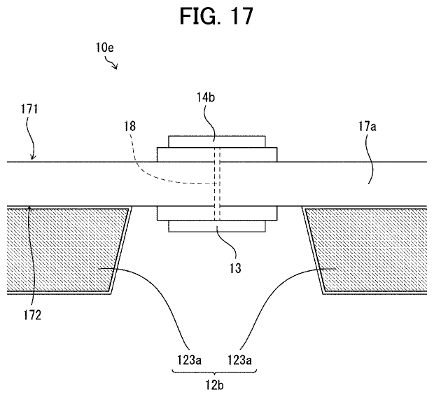

The following will describe Embodiment 5 of the present disclosure. FIG. 16 is a schematic view of a cold insulator 10e in accordance with Embodiment 5. The drawing shown in denotation 161 of FIG. 16 is a front view of the cold insulator 10e. The drawing shown in denotation 162 of FIG. 16 is a cross-sectional view showing a cross-section taken along break line B-B′ in the drawing shown in denotation 161. In addition, FIG. 17 is an enlarged view of a portion near a connection unit 17a of a drawing shown in denotation 162 in FIG. 16.

Referring to FIGS. 16 and 17, the cold insulator 10e is a cold insulator of a “blister pack” type and differs from the cold insulator 10 in that the cold insulator 10e includes a plurality of cold storage materials 11, a packaging unit 12b, a transmission unit 14b, and the connection unit 17a. The packaging unit 12b includes a plurality of packaging areas 123a, and each packaging area 123a packages one of the cold storage materials 11. The connection unit 17a closes gaps between the packaging areas 123a. The connection unit 17a has a platelike shape and is, for example, shaped like a film. The packaging areas 123a are disposed on a first face 171 that is one of the two faces of the connection unit 17a. As an example, the connection unit 17a of the cold insulator 10e is a substantially flat laminate film, and the packaging unit 12b is an irregular laminate film. The cold insulator 10e is formed by attaching the connection unit 17a and the packaging unit 12b together in such a manner that the lumps of the packaging unit 12b provide the packaging areas 123a. Note that although FIG. 16 shows an example where there are six packaging areas 123a, the number of the packaging areas 123a is not limited to this.

Referring to FIG. 17, in the cold insulator 10e, the first temperature sensor 13 is preferably disposed on the first face of the connection unit 17a, and the transmission unit 14b is preferably disposed on a second face 172 opposite from the first face 171 of the connection unit 17a. In such a case, the first temperature sensor 13 and the transmission unit 14b are electrically connected by wiring 18.

### Effects of Cold Insulator 10e

In the cold insulator 10e, the packaging areas 123a, packaging the cold storage materials 11, and the first temperature sensor 13 are disposed on the first face 171 of the connection unit 17a. This structure allows the first temperature sensor 13 to be located close to the cold storage materials 11, which enables precise measurement of the temperature of the cold storage materials 11.

Additionally, the transmission unit 14b is disposed on the second face 172 of the connection unit 17a. This structure moves the transmission unit 14b and the cold storage materials 11 away from each other. Therefore, even when the cold storage materials 11 are a water-based coolant, the possibility can be reduced of the radio waves emanating from the transmission unit 14b being absorbed by the cold storage materials 11.

### Embodiment 6

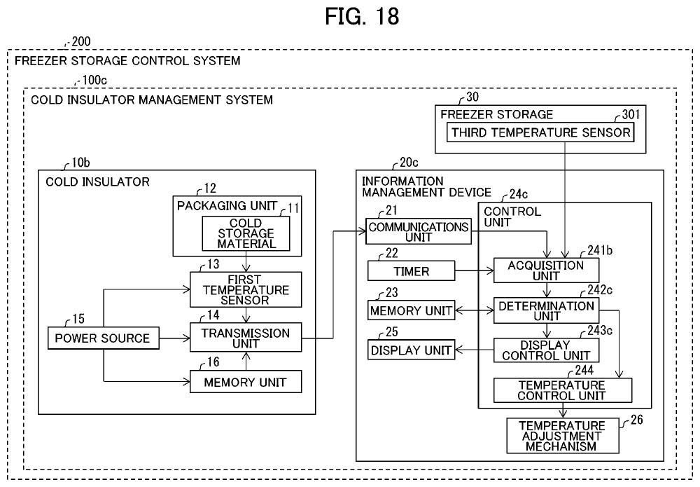

The following will describe Embodiment 6 of the present disclosure. FIG. 18 is a block diagram of a structure of a freezer storage control system 200 in accordance with Embodiment 6.

### Structure of Freezer Storage Control System 200

The freezer storage control system 200 is a system for controlling the temperature of a freezer storage 30 for freezing the cold insulator 10. In the present embodiment, the functions of the freezer storage control system 200 are realized by a cold insulator management system 100c. Retelling to FIG. 18, the cold insulator management system 100c, as the freezer storage control system 200, includes an information management device 20c and the freezer storage 30. The cold insulator management system 100c further includes any of the cold insulators 10 to 10e in accordance with. Embodiments 1 to 5. The following will describe, as an example, an example where the cold insulator management system 100c includes a plurality of cold insulators 10b.

The freezer storage 30 includes a third temperature sensor 301. The third temperature sensor 301 is a temperature sensor for measuring the internal temperature of the freezer storage 30 for freezing the cold insulators 10b as ambient temperature. Additionally, at least one of the cold insulators 10b is placed inside the freezer storage 30.

The information management device 20c includes a control unit 24c and a temperature adjustment mechanism 26 as well as the communications unit 21, the timer 22, the memory unit 23, and the display unit 25.

The temperature adjustment mechanism 26 adjusts the internal temperature of the freezer storage 30 under control of a temperature control unit 244 (detailed later). In other words, the temperature adjustment mechanism 26 adjusts the internal temperature of the freezer storage 30 on the basis of a result of measurement made by the first temperature sensor 13 of the cold insulator 10b placed inside the freezer storage 30. The temperature adjustment mechanism 26 may be, for example, a control circuit that controls, for example, a feeder or coolant in the freezer storage 30, to control the internal temperature of the freezer storage 30.

The control unit 24c differs from the information management device 20 in accordance with Embodiment 1 in that the control unit 24c includes an acquisition unit 241b, a determination unit 242c, and a display control unit 243c in place of the acquisition unit 241, the determination unit 242, and the display control unit 243 and further includes the temperature control unit 244. The acquisition unit 241b acquires the information temperature information and the first identification information from the cold insulators 10b stored in the freezer storage 30 and also acquires ambient temperature information from the third temperature sensor 301, all for output to the determination unit 242c.

The determination unit 242c determines whether or not the cold storage materials 11 included in the plurality of cold insulators 10b are all frozen. If the determination unit 242c has determined that the cold storage materials 11 included in the plurality of cold insulators 10b are all frozen, the temperature control unit 244 controls the temperature adjustment mechanism 26 to raise the temperature of the freezer storage 30. On the other hand, if the determination unit 242c has determined that some of the cold storage materials 11 included in the plurality of cold insulators 10b are not frozen, the temperature control unit 244 controls the temperature adjustment mechanism 26 to lower the temperature of the freezer storage 30.

### Exemplary Process by Freezer Storage Control System 200

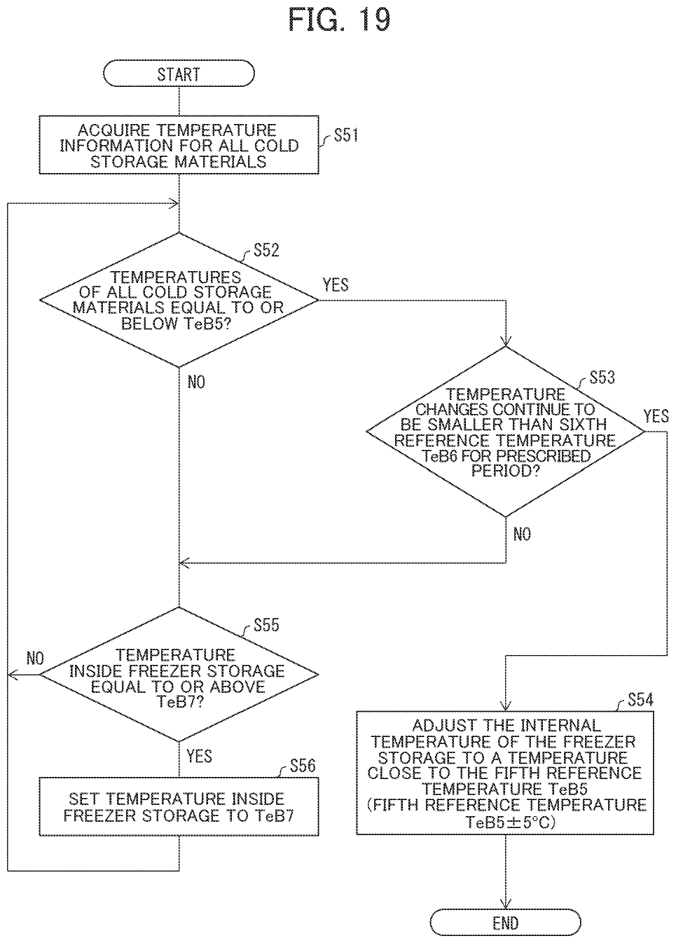

The following will describe an exemplary process implemented by the freezer storage control system 200 with reference to FIG. 19, FIG. 19 is a flow chart representing an exemplary flow of a process implemented by the freezer storage control system 200. The determination unit 242c, upon acquiring the temperature information for all the cold insulators 10b included in the freezer storage control system 200 and the ambient temperature information inside the freezer from the acquisition unit 241b (S51), refers to the memory unit 23 to acquire a fifth reference temperature TeB5. The fifth reference temperature TeB5 is a predetermined temperature and is set to a maximum temperature at which the cold storage materials 11 are frozen. The determination unit 242c compares the temperature information with the fifth reference temperature TeB5 to determine whether or not the temperature of the cold storage material 11 is lower than or equal to the fifth reference temperature TeB5 for all the cold insulators 10b (S52).

If the temperature of the cold storage material 11 is below the fifth reference temperature for all the cold insulators 10b (YES in step S52), the determination unit 242c further refers to the memory unit 23 to acquire information on the temperature Te1 of the cold storage materials 11 recorded up to a prescribed period (e.g., 5 minutes) prior to the current time and also acquire a sixth reference temperature TeB6. The temperature of the cold storage material 11 varies less when the cold storage material 11 is frozen than when the cold storage material 11 is not frozen. Therefore, the cold storage material 11 can be determined to have been frozen if temporal changes in the temperature of the cold storage material 11 continue to be smaller than a prescribed value for a prescribed period (e.g., 5 minutes). As the sixth reference temperature TeB6, a temperature difference based on which the cold storage material 11 is determined to have been frozen is set.

The determination unit 242c determines whether or not changes in the temperature of the cold storage material 11 in each cold insulator 10b continue to be smaller than the sixth reference temperature TeB6 for a prescribed period, in other words, whether or not all the cold storage materials 11 are frozen (S53). If the determination unit 242c has determined that the cold storage materials 11 included in all the cold insulators 10b are frozen (YES in step S53), the determination unit 242c outputs this result of determination to the display control unit 243c. The display control unit 243c, upon acquiring the result of determination, controls the display unit 25 to display to the effect that the cold storage materials 11 included in all the cold insulators 10b are frozen.

Subsequently, the determination unit 242c outputs this result of determination to the temperature control unit 244. The temperature control unit 244, upon acquiring the result of determination, controls the temperature adjustment mechanism 26 to adjust the internal temperature of the freezer storage 30 to a temperature close to the fifth reference temperature Te135 (fifth reference temperature TeB5±5° C.) (S54).

On the other hand, if the temperature(s) Te1 of the cold storage material(s) 11 in one or more of the cold insulators 10b is/are above the fifth reference temperature (NO in step S52), the determination unit 242c determines that one or more of the cold storage materials 11 is/are not frozen.

In addition, if one or more of the cold storage materials 11 has/have shown a temperature change larger than the sixth reference temperature TeB6 in the prescribed period (NO in step S53), the determination unit 242c determines that one or more of the plurality of cold storage materials 11 is/are not frozen.

The determination unit 242c, upon determining that one or more of the plurality of cold storage materials 11 is/are not frozen, outputs this result of determination to the display control unit 243c. The display control unit 243c, upon acquiring the result of determination, controls the display unit 25 to display to the effect that one or more of the cold storage materials 11 is/are not frozen. Alternatively, the display control unit 243c controls the display unit 25 to display information on the unfrozen cold storage material(s) 11.

Subsequently, the determination unit 242c, upon determining that one or more of the plurality of cold storage materials 11 is/are not frozen, determines whether or not ambient temperature is equal to or above a seventh reference temperature TeB7 (S55). The seventh reference temperature TeB7 is set to a temperature equal to or below the freezing point of the cold storage material 11.

If the determination unit 242c has determined that ambient temperature is equal to or above the seventh reference temperature TeB7 (YES in step S55), the determination unit 242c outputs this result of determination to the temperature control unit 244, The temperature control unit 244, upon acquiring the result of determination, controls the temperature adjustment mechanism 26 to lower the temperature of the freezer storage 30 toward the seventh reference temperature (S56). After S56, the process returns to S52, On the other hand, if the determination unit 242c has determined that ambient temperature is below the seventh reference temperature TeB7 (NO in step S55), the process returns to step S52.

### Effects of Freezer Storage Control System 200

The freezer storage control system 200 includes the cold insulator management system 100c, the third temperature sensor 301, and the temperature adjustment mechanism 26. By this structure, the freezer storage control system 200 can determine whether or not the cold storage material 11 contained in the freezer storage 30 is frozen. In addition, when the freezer storage control system 200 includes a plurality of cold insulators 10b, the freezer storage control system 200 can determine Whether or not all the cold storage materials 11 included in the respective cold insulators 10b are frozen.

Conventionally, when the cold insulators 10b are to be used, the cold insulators 10b need to be left, to sit for a while so that the temperature Te1 of the cold storage materials 11 can rise, to avoid excess cooling of the object to be kept cold X with the cold storage materials 11. Here, if all the cold storage materials 11 are frozen, the freezer storage control system 200 elevates the temperature of the freezer storage 30 to the fifth reference temperature TeB5. This process maintains the temperature Te1 of the cold storage materials 11 near the fifth reference temperature TeB5 and therefore eliminates the need for the cold insulators 10b to be left to sit as described above. In addition, when all the cold storage materials 11 are frozen, the electric power consumption of the freezer storage 30 can be reduced by elevating the temperature of the freezer storage 30.

In addition, when one or more of the cold storage materials 11 is/are not frozen, since the temperature of the freezer storage 30 is lowered, the cold storage materials 11 can be efficiently frozen.

### Variation Examples

When the cold storage material 11 is a coolant that supercools in freezing, the temperature of the cold storage material 11, when the cold storage material 11 freezes, temporarily dips below the fifth reference temperature TeB5, then rises to a temperature near the fifth reference temperature TeB5, and subsequently decreases. In this case, the determination unit 242c determines whether or not following S53 described in Embodiment 6, the temperature Te1 of the cold storage material 11 dipped below the fifth reference temperature TeB5 and subsequently started to rise. If the temperature Te1 of the cold storage material 11 dipped below the fifth reference temperature TeB5 and subsequently started to rise, the determination unit 242b determines that the cold storage material 11 has been frozen. On the other hand, if the temperature Te1 of the cold storage material 11 did not dip below the fifth reference temperature TeB5 and subsequently start to rise, the determination unit 242b determines that the cold storage material 11 has not been frozen.

In addition, when the freezer storage control system 200 includes a plurality of cold insulators 10b, when the plurality of cold insulators 10b contains a plurality of types of cold storage materials 11, the lowest of the freezing temperatures of the plurality of types of cold storage materials 11 is selected as the fifth reference temperature TeB5.

### Software Implementation

The control blocks of the information management devices 20 to 20c (particularly, the acquisition units 241 to 241b, the determination units 242 to 242c, the display control units 243 to 243c, and the temperature control unit 244) may be implemented by logic circuits (hardware) fabricated, for example, in the form of integrated circuits (IC chips) and may be implemented by software.

In the latter form of implementation, the information management devices 20 to 20c include a computer that executes instructions from programs or software by which various functions are provided. This computer includes, for example, at least one processor (control device) and at least one computer-readable storage medium containing the programs. The processor in the computer then retrieves and runs the programs contained in the storage medium, thereby achieving the object of the present disclosure. The processor may be, for example, a CPU (central processing unit). The storage medium may be a “non-transitory, tangible medium” such as a ROM (read-only memory), a tape, a disc/disk, a card, a semiconductor memory, or programmable logic circuitry. The computer may further include, for example, a RAM (random access memory) for loading the programs. The programs may be supplied to the computer via any transmission medium (e.g., over a communications network or by broadcasting waves) that can transmit the programs. Note that the present disclosure, in an aspect thereof, encompasses data signals on a carrier wave that are generated during electronic transmission of the programs.

The present disclosure is not limited to the description of the embodiments above and may be altered within the scope of the claims. Embodiments based on a proper combination of technical means disclosed in different embodiments are encompassed in the technical scope of the present disclosure. Furthermore, new technological features can be created by combining different technical means disclosed in the embodiments.

1. A cold insulator comprising:
at least one cold storage material;
a packaging unit configured to package the at least one cold storage material;
one or more temperature sensors disposed on the packaging unit; and
a transmission unit disposed on the packaging unit to transmit a result of measurement performed by the one or more temperature sensors to an external device.

2. The cold insulator according to claim 1, wherein at least one of the one or more temperature sensors is a temperature sensor disposed on a portion of the packaging unit in a location overlapping the at least one cold storage material.

3. The cold insulator according to claim 1 or 2, wherein at least one of the one or more temperature sensors is a temperature sensor disposed on a part of a peripheral portion of the packaging unit.

4. The cold insulator according to claim 1, wherein
the one or more temperature sensors include two or more temperature sensors, and
one of two temperature sensors of the two or more temperature sensors is disposed on a portion of the packaging unit in a location overlapping the at least one cold storage material, and another one of the two temperature sensors is disposed on a part of a peripheral portion of the packaging unit.

5. The cold insulator according to any one of claims 1 to 4, wherein
the packaging unit includes a plurality of packaging areas configured to package the at least one cold storage material,
the packaging unit includes at least one connection unit configured to close gaps between the plurality of packaging areas, and
the transmission unit is disposed on at least one of the at least one connection unit.

6. The cold insulator according to claim 5, wherein at least one of the one or more temperature sensors is/are disposed on the at least one connection unit.

7. The cold insulator according to claim 6, wherein
the at least one connection unit has a platelike shape,
the plurality of packaging areas is disposed on a first face of the at least one connection unit,
the one or more temperature sensors is/are disposed on the first face, and
the transmission unit is disposed on a second face, of the at least one connection unit, opposite from the first face.

8. The cold insulator according to any one of claims 5 to 7, wherein each of the plurality of packaging areas is covered with a metal.

9. The cold insulator according to any one of claims 1 to 8, wherein
the cold insulator is assigned unique identification information, and
the transmission unit transmits the unique identification information to the external device.

10. An information management device, as the external device, to be connected in a communicable manner to the cold insulator according to any one of claims 1 to 9 to perform management based on temperature information, as the result of measurement, transmitted from the cold insulator, the information management device comprising:
a communications unit configured to receive the temperature information from the transmission unit; and
a determination unit configured to make a determination on information on the cold insulator based on the temperature information.

11. A cold insulator management system comprising:
two or more cold insulators according to any one of claims 1 to 9; and
the information management device according to claim 10, wherein
each of the two or more cold insulators is assigned unique identification information,
the transmission unit included in each of the two or more cold insulators transmits, to the information management device, the temperature information, as the result of measurement, measured by the one or more temperature sensors included in each of the two or more cold insulators and the unique identification information assigned to each of the two or more cold insulators,
the information management device stores the temperature information and the unique identification information, both transmitted from each of the two or more cold insulators, in association with each of the two or more cold insulators, and
the determination unit identifies one of the two or more cold insulators that is available for use, by referring to the temperature information and the unique identification information both associated with each of the two or more cold insulators and also to cold storage reference temperature of an object to be kept cold.

12. A freezer storage control system comprising the cold insulator management system according to claim 11 further comprising a freezer storage configured to contain at least one of the two or more cold insulators to function as the freezer storage control system that controls the freezer storage, wherein
the information management device further comprises a control circuit configured to control an internal temperature of the freezer storage based on the result of measurement performed by the one or more temperature sensors included in the two or more cold insulators contained in the freezer storage.
